(19) United States
(12) Patent Application Publication
(10) Pub. No.: US 2025/0369226 A1
(43) Pub. Date: Dec. 4, 2025

(54) ROOFING SHINGLES INCLUDING FILLED ASPHALT MATERIAL AND METHODS FOR MAKING THE SAME

(71) Applicant: HONEYWELL INTERNATIONAL INC., Charlotte, NC (US)

(72) Inventors: Yonghong RUAN, Wayne, NJ (US); Scott HACKER, River Edge, NJ (US)

(73) Assignee: HONEYWELL INTERNATIONAL INC., Charlotte, NC (US)

(21) Appl. No.: 19/304,786

(22) Filed: Aug. 20, 2025

Related U.S. Application Data
(63) Continuation-in-part of application No. 17/307,723, filed on May 4, 2021.
(60) Provisional application No. 63/019,557, filed on May 4, 2020.
(60) Provisional application No. 63/118,613, filed on Nov. 25, 2020.

(51) Int. Cl. E04D 1/20; C08L 95/00; E04D 1/34

(52) U.S. Cl. CPC E04D 1/20; C08L 95/00; C08L 2555/50; C08L 2666/54; E04D 2001/3435

(57) ABSTRACT

Roofing shingles and methods of producing the same are provided. In accordance with an exemplary embodiment, a roofing shingle includes a substrate having a substrate weight of from about 65 to about 90 grams per square meter. The roofing shingle also includes a filled asphalt material disposed on the substrate, where the filled asphalt material comprises an asphalt composition and a filler. The asphalt composition comprises a base asphalt that is unoxidized and a low molecular weight polyolefin present in the asphalt composition in an amount of from about 0.5 to about 25 weight percent. The filler comprises calcium carbonate in an amount of from 0 to about 90 weight percent.

### CROSS-REFERENCE TO RELATED APPLICATIONS

This application is a continuation in part of pending U.S. patent application Ser. No. 17/307,723, filed May 4, 2021, which is related to and claims all available benefit of U.S. Provisional Patent Application 63/019,557 filed May 4, 2020 and U.S. Provisional Patent Application 63/118,613 filed Nov. 25, 2020, the entire contents of which are herein incorporated by reference.

### TECHNICAL FIELD

The technical field relates generally to roofing shingles. More particularly, the technical field relates to roofing shingles including filled asphalt material and methods for making the same.

### BACKGROUND

Asphalt, or bitumen, is commonly collected or synthesized and refined for use in paving and roofing applications. There are several different types of asphalt having varying properties, allowing asphalt to be used in various application. In general, asphalt suitable for roofing applications is commonly referred to as “roofing flux,” “flux asphalt,” or simply “flux.” It is common to modify roofing flux by a process called “air blow,” or “oxidation,” to make the roofing flux harder and, therefore, more suitable for roofing applications. The product of such air blow processes is called “blown coating” or “oxidized asphalt” or “oxidized bitumen” and is suitable for use to make roofing products, such as roofing shingles. The air blow or oxidation is an energy intensive operation with a potential for adverse environmental effects because of the off-gases when air is blown through the hot asphalt.

In general, roofing shingles are produced by mixing a blown coating, or other asphalt composition with a filler and applying the filled coating to both sides of, for example, a fiberglass mat. Additional layers such as a granular top layer and/or backing sand(s) and adhesives may also be applied to the roofing shingle. The types of filler(s) and mat(s) used for roofing shingles can be modified and adjusted, depending on specification and manufacturing requirements.

ASTM D3462 outlines the requirements that roofing shingle manufacturers must meet for the production of asphalt roofing in shingle form. For example, standards relating to physical properties of the roofing shingle such as tear strength are of relevance to roofing shingle manufacture. However, poor interactions between the blown coating, the filler, and the fiberglass mat make such standards difficult to achieve. It is often the case that shingle manufacturers must use heavy fiberglass mats and/or high-purity limestone filler in order to meet the physical property requirements outlined in ASTM D3462 such as those for tear strength. Unfortunately, the use of heavy fiberglass mats and high-purity limestone filler in roofing shingles substantially increases the cost of production to the manufacture. As such, these roofing shingles are heavier than necessary and more expensive to produce than is optimal, coming at the expense of both manufacturers and consumers alike.

According to technical brief bulletin FHWA-H1F-22-001, published by Federal Highway Administration (FHWA), US Department of Transportation (DOT) in August 2021, the US generates around 13.2 to 17.0 million tons of reclaimed asphalt shingle (RAS) each year and less than 1.0 million (<8%) tons of RAS is recycled. Most of the RAS, 12.0 to 16.0 million tons, goes to landfilling annually. Out of 28 state Department Of Transportations (DOTs) allowing RAS in road paving projects, most DOTs limit the amount of RAS in road paving projects to an amount of less than or equal to 5% of the total paving mixture due to concern on asphalt embrittlement in RAS. Asphalt in RAS is often highly oxidized (from the air blowing process used to shingle asphalt), heavily aged, and much stiffer and brittle than paving asphalt, which will reduce the resistance of a paving asphalt mixture to fatigue cracking and thermal cracking.

Accordingly, it is desirable to provide a roofing shingle that addresses one or more of the foregoing issues and methods for making such roofing shingles. Furthermore, other desirable features and characteristics of the various embodiments described herein will become apparent from the subsequent detailed description and the appended claims, taken in conjunction with the accompanying drawings and this background.

### SUMMARY

Roofing shingles and methods of producing the same are provided. In accordance with an exemplary embodiment, a roofing shingle includes a substrate having a substrate weight of from about 65 to about 90 grams per square meter. The roofing shingle also includes a filled asphalt material disposed on the substrate, where the filled asphalt material comprises an asphalt composition and a filler. The asphalt composition comprises a base asphalt that is unoxidized and a low molecular weight polyolefin present in the asphalt composition in an amount of from about 0.5 to about 25 weight percent. The filler comprises calcium carbonate in an amount of from 0 to about 90 weight percent.

A method for making a roofing shingle is provided in another embodiment. The method includes applying a filled asphalt material to a substrate, where the substrate has a substrate weight of from about 65 to about 90 grams per square meter. The filled asphalt material comprises an asphalt composition and a filler. The asphalt composition includes a base asphalt that is unoxidized, and a low molecular weight polyolefin present in an amount of from about 0.5 to abut 25 weight percent. The filler comprises calcium carbonate in an amount of from 0 to about 90 weight percent.

### BRIEF DESCRIPTION OF THE DRAWINGS

The various embodiments will hereinafter be described in conjunction with the following drawing figures, wherein like numerals denote like elements, and wherein:

FIG. 1 illustrates a cross-sectional side view of a roofing shingle in accordance with an exemplary embodiment; and

FIG. 2 illustrates a block diagram of a method for making a roofing shingle in accordance with an exemplary embodiment.

### DETAILED DESCRIPTION

The following Detailed Description is merely exemplary in nature and is not intended to limit the various embodiments or the application and uses thereof. Furthermore, there is no intention to be bound by any theory presented in the preceding background or the following detailed description.

The various embodiments contemplated herein relate to roofing shingles, methods for making roofing shingles, and asphalt compositions. In an exemplary embodiment, the roofing shingle includes a substrate and a filled asphalt material that is disposed on the substrate. The filled asphalt material includes an asphalt composition and a filler. The asphalt composition comprises base asphalt and a low molecular weight (MW) polyolefin present in an amount of from about 0.5 to about 25.0% by weight based on the total weight of the asphalt composition.

Without wishing to be bound by theory, it is believed that the use of low MW polyolefin in the asphalt composition results in strengthened interaction(s) between the asphalt composition, the filler, and the substrate. For example, the low MW polyolefin may modify and/or optimize material surface and rheological properties of the asphalt composition leading to, for example, better adhesion/bonding between the layers of the roofing shingle and/or enhanced tear strength of the roofing shingle. Advantageously, the use of low MW polyolefin in the asphalt composition allows for more economical roofing shingles. This is due at least in part to the use of low MW polyolefin in the roofing shingle eliminating the need for, for example, heavy fiberglass mats to be used as substrate and/or high-purity limestone to be used as filler. Accordingly, lighter weight and/or thinner substrates and more economical fillers can be used in these roofing shingles while maintaining ASTM D3462 compliance.

Asphalt compositions do not have distinct melting points, but rather a range of temperatures within which the materials begin and continue to soften without melting. It is beneficial to know the temperature ranges in which asphalt compositions will become too soft to be used in construction and manufacturing and, therefore, the softening point of an asphalt composition is an important characteristic to be measured. Asphalt compositions suitable for use in roofing applications and products should have a softening point of from about 88 to about 113 degrees Celsius (° C.) for air blown asphalt and to about 160° C. for polymer modified asphalt. It is desired that the asphalt composition has a softening point, in ° C., of at least about 90.6, 93.3, 96.1, 98.9, 101.7, 104.4, 110, 112.8, 115.6, 121.1, or 126.7° C., and independently, in° C., of not more than about 157.2, 154.4, 151.7, or 148.9° C. In an exemplary embodiment, the softening point is determined in accordance with the procedures of ASTM D36 (a “ring and ball” method, “R&B SP”).

The penetration test provides a measure of the consistency of an asphalt material at a given temperature. The consistency is a function of the types of chemical constituents of the asphalt and their relative amounts in the asphalt, which are determined by the source petroleum and the method of processing at the refinery. The penetration is measured using a standard needle which is brought to the surface of the asphalt specimen, at right angles, and allowed to penetrate the asphalt for a period such as 5 seconds under a 100 grams load, while the temperature of the specimen is maintained at a certain value, such as 25° C. The penetration is measured in tenths of a millimeter (deci-millimeter, 0.1 mm, 1 dmm) and the deeper the needle penetrates into the asphalt specimen, the larger the reported value, and the softer the asphalt.

Furthermore, asphalt compositions intended for use in asphalt roofing products may have a penetration value, at 25° C., of greater than about 10 dmm, such as for example, greater than about 12 dmm. It is desired that the asphalt composition has a penetration value, in dmm, of greater than about 10, 12, 15, 20, or 25, and independently, of not more than about 75, 70, 60, 55, 50, 45, 40, 35, 30, 25, or 20. For example, the asphalt composition may have a penetration value of from about 15 to about 30, more preferably from about 16 to about 24. In an exemplary embodiment, the penetration value is determined in accordance with the procedures of ASTM D5 at 25° C.

The advantageous softening point (SP) and penetration (PEN) characteristics of asphalt compositions may be reported together, as complementary characteristics. For example, without limitation, the asphalt composition as contemplated herein for use in asphalt roofing applications may have a SP of from about 88 to about 160° C. with a PEN at 25° C. of greater than about 15 dmm, or a SP of from about 90.6 to about 104.4° C. with a PEN at 25° C. of from about 15 to about 40 dmm, or a SP of from about 93.3 to about 96.1° C. with a PEN at 25° C. of from about 15 to about 25 dmm. In some embodiments, the asphalt compositions will have a SP of from about 88 to about 160° C. with a PEN at 25° C. of from about 15 to about 26 dmm, or a SP of from about 98.9 to about 148.9° C. with a PEN at 25° C. of from about 20 to about 50 dmm, or a SP of from about 121.1 to about 160° C. with a PEN of at 25° C. from about 15 to about 40 dmm, to be suitable for use in asphalt roofing products and applications.

As noted above, the roofing shingle contemplated herein includes a substrate and a filled asphalt material that includes an asphalt composition and a filler. The asphalt composition includes base asphalt and a low MW polyolefin. In an exemplary embodiment, the base asphalt is present in an amount of from about 55 to about 99.5% by weight, such as from about 65 to about 99.5% by weight, for example from about 75 to about 99.5% by weight based on the total weight of the asphalt composition. All types of asphalt, naturally occurring, synthetically manufactured and modified or combinations thereof, may be used as the base asphalt in accordance with the asphalt composition contemplated herein. Naturally occurring asphalt is inclusive of native rock asphalt such as Buton asphalt or a uintaite material, lake asphalt, and the like. Synthetically manufactured asphalt is often a byproduct of petroleum refining operations and includes air-blown (oxidized) asphalt, blended asphalt, cracked, residual or recycled asphalt, petroleum asphalt, solvent de-asphalted asphalt (SDA) especially propane de-asphalted asphalt (PDA), straight-run asphalt, pitch, low penetration asphalt, zero-penetration asphalt, and the like, including combinations thereof. Modified asphalt includes base asphalt (e.g., neat or unmodified asphalt that can be naturally occurring or synthetically manufactured) modified with elastomers, plastomers, or various combinations of these.

The asphalt Performance Grade (PG) rating system categorizes asphalt compositions used in asphalt products based on the asphalt composition's performance at different temperatures. An asphalt composition having a PG rating of about 64-22, for example, means that the asphalt composition can be used in a climate where the pavement end product reaches temperatures as high as +64° C. and as low as −22° C. Temperatures outside the PG range of the asphalt composition usually lead to deterioration of the asphalt product in which it is used.

“Base asphalt,” as this term is used herein is bitumen, or asphalt, which is defined by the ASTM as a dark brown to black cementitious material in which the predominant constituents are bitumens that occur in nature or are obtained in petroleum processing. Asphalts typically contain saturates, aromatics, resins and asphaltenes. Base asphalt is an organic material that is not polymeric.

The type of asphalt typically suitable for paving applications is commonly referred to as “paving grade asphalt,” or “paving asphalt,” or “asphalt cement.” Asphalt that is typically suitable for roofing applications is commonly referred to as “roofing flux,” “flux asphalt,” or simply “flux.” In general, paving asphalt is harder than roofing flux, as indicated by their penetration grade. The most popularly used paving asphalt has a penetration of around 50/70 or 60/90 dmm (0.1 millimeters), and on the other hand, roofing flux's penetration is generally above 150-200 dmm. Accordingly, roofing flux is not often used directly, especially for roofing shingle manufacturing, because it is too soft. Rather, a process called “air blow” is applied to roofing flux to make it harder and, therefore, more suitable for roofing applications. During the air blow process, air is bubbled through hot liquid roofing flux for a certain amount of time (e.g., 2 to 8 hours). Oxygen in the air reacts with asphalt flux and its stiffness is thereby increased dramatically, indicated by penetration of the roofing flux dropping from greater than about 150-200 dmm to about 20 dmm. The product of such air blow processes is called “blown coating” or “oxidized asphalt” or “oxidized bitumen” and is useful for making roofing products, such as roofing shingles. In an exemplary embodiment, the base asphalt of the asphalt composition is oxidized asphalt.

“Non-oxidized base asphalt,” as this term is used herein, includes base asphalt that has not been subjected to or undergone an oxidizing, or air blowing, step as that process has been described hereinabove. In an exemplary embodiment, the base asphalt of the asphalt composition is non-oxidized asphalt.

In an exemplary embodiment, the low MW polyolefin is present in the asphalt composition in an amount of from about 0.5 to about 25.0% by weight based on the total weight of the asphalt composition. “Low MW polyolefin,” as this term is used herein, means an olefin-containing polymer, or a blend of two or more olefin-containing polymers, each of which has a weight average molecular weight (M_{w}) of from about 500 to about 20,000 Daltons, and includes from about 80 to about 100% by weight, based on the total weight of the low MW polyolefin, of one or more olefinic monomers selected from: ethylene, propylene, butene, hexene, and octene. Thus, the low MW polyolefins may be homopolymers including only a single type of olefin monomer, or copolymers including two or more types of olefin monomers. Furthermore, low MW polyolefins, as this term is used herein, include but are not limited to polyolefin waxes, i.e., polyolefins which are solid at or near room temperature and have low viscosity when above their melting point. Some Fischer-Tropsch waxes, i.e., those that satisfy the above-defined characteristics of low molecular weight polyolefins but are produced from carbon monoxide and hydrogen, may also be used in the binder compositions contemplated and described herein as, or in place of, or in combination with, the low MW polyolefin.

Thermally degraded waxes are also examples of LMW polyolefins, where the thermally degraded waxes have a weight average molecular weight with the limit of from about 500 to about 20,000 Daltons, as mentioned above. The thermally degraded waxes may be formed from virgin polymers or recycled polymers.

In an exemplary embodiment, the LMW polyolefin is an oxidized high density polyethylene. Unoxidized high density polyethylene has a density of from about 0.93 to about 0.97 grams per cubic centimeter (g/cc) or higher, and oxidized high density polyethylene has a density equal to or greater than the unoxidized high density polyethylene depending on the degree of oxidation. An exemplary oxidized high density polyethylene has a density of at least 0.93, 0.94, 0.95, 0.96, 0.97, 0.98, 0.99, or 1.00 g/cc. In contrast, low density unoxidized polyethylene has a density of from about 0.91 to about 0.93 g/cc. Oxidized low density polyethylene also has a density of about 0.93 g/cc, as the term is used herein. Low density polyethylene tends to include multiple branches in the polymer chain, whereas high density polyethylene has minimal polymer branching. Oxidized polyethylene is a reaction product of polyethylene with oxygen-containing gases, and may be produced by different techniques. Oxidized polyolefins will have an acid number, defined as the amount of potassium hydroxide in milligrams required to neutralize 1 gram of polyolefin under fixed conditions. One set of fixed conditions, for example, would be as defined in ASTM 1386-83.

In an exemplary embodiment, the low MW polyolefin has an olefin content of from about 50 to about 100 wt. %, based on the total weight of the low MW polyolefin. It is desired that the low MW polyolefin has an olefin content in wt. %, based on the total weight of the low MW polyolefin, of at least about 55, 60, 65, 70, 75, 80, 85, 90, or 95, and independently, of not more than about 98, 95, 92, 90, 85, 80, or 75.

As already mentioned, the low MW polyolefin has a M_{w} of from about 500 to about 20,000 Daltons. It is desired that the low MW polyolefin has a M_{w} in Daltons of at least about 500, 1,000, 2,000, 3,000, 4,000, 5,000, 6,000, or 7,000, and independently, of not more than about 20,000, 18,000, 15,000, 12,000, or 10,000. Where the low MW polyolefin includes a combination of more than one type of polyolefin, the M_{w} of each type of polyolefin in the combination shall individually be within the above-stated range of about 500 to about 20,000 Daltons.

In an exemplary embodiment, the weight average (and number average) molecular weight can be determined by any process well-known in the art such as by gel permeation chromatography (GPC). For example, in the process of GPC, the sample to be measured is dissolved in 1,2,4-trichlorobenzene at 140° C. at a concentration of about 2.0 mg/ml. The solution (100 uL) is injected into the GPC containing Shodex Two AT-80 MS columns held at 140° C. with a flow rate of 1.0 mL/minute. The instrument is equipped with two detectors (refractive index and viscosity detector). The molecular weight (weight average molecular weight, Mw) is determined using a calibration curve generated from a set of linear polyethylene narrow molecular weight standards.

In an exemplary embodiment, the low MW polyolefin is selected from the group of functionalized polyolefin, non-functionalized polyolefin, Fischer-Tropsch waxes, thermally degraded waxes, and combinations thereof, wherein the Fischer-Tropsch waxes, the thermally degraded waxes, and the polyolefins have a weight average molecular weight of from about 500 to about 20,000 Daltons. Functionalized low MW polyolefins may be modified homopolymers, copolymers, or modified copolymers. Further, functionalized low MW polyolefins include one or more functional groups including for example, without limitation, an acid, an ester, an amine, an amide, an epoxide, and anhydride. In an exemplary embodiment, the functionalized polyolefin is selected from the group of oxidized high-density polyethylene, maleic anhydride-grafted polypropylene, maleic anhydride-grafted polyethylene, maleic anhydride-grafted poly(ethylene-co-propylene), polyethylene-vinyl acetate, ethylene-acrylic acid copolymer, oxidized low-density polyethylene, oxidized polyethylene-vinyl acetate, epoxy-functionalized polyolefin, and combinations thereof. In an exemplary embodiment, the non-functionalized polyolefin is selected from the group of polyethylene, polypropylene, and combinations thereof. In an exemplary embodiment, the low MW polyolefin includes an oxidized high-density polyethylene.

Some Fischer-Tropsch waxes, i.e., those that satisfy the above-defined characteristics of low molecular weight polyolefins but are produced from carbon monoxide and hydrogen, may be utilized in the binder compositions contemplated and described herein as the low MW polyolefin. Thermally degraded waxes are also examples of LMW polyolefins, where the thermally degraded waxes have a weight average molecular weight with the limit of from about 500 to about 20,000 Daltons, as mentioned above. The thermally degraded waxes may be formed from virgin polymers or recycled polymers.

One category of suitable low MW polyolefin includes certain HONEYWELL TITAN® polyolefins, which include functionalized and non-functionalized polyethylene or polypropylene and are commercially available from Honeywell International Inc., located in Charlotte, North Carolina, U.S.A. More particularly, one or more of the HONEYWELL TITAN® 8062, 8058, 8903, 8587, 8760, 8636, 8459, 8822, 8880, 8932, 8145, 8187, 8087, 8675, 8594, 8570, 8624, 8422, and 8133 and/or one or more of the A-CX® 2069, 2070, and 2071 are suitable for use as the low MW polyolefin.

In an exemplary embodiment, the low MW polyolefin is present in the asphalt composition in an amount of from about 0.5 to about 25% by weight based on the total weight of the asphalt composition. It is desired that the low MW polyolefin is present in the asphalt composition in an amount, in wt. %, based on the total weight of the asphalt composition of at least about 0.5, 0.6, 0.7, 0.8, 0.9, 1.0, 1.2, 1.5, 1.8, 2.0, 2.2, 2.5, 3.0, 4.0, 5.0, 6.0, 7.0, or 8.0 and independently, of not more than about 25.0, 20.0, 15.0, 14.0, 13.0, 12.0, 11.5, 11.0, 10.5, 10.0, 9.5, 9.0, 8.5, 8.0, 7.5, 7.0, 6.5, 6.0, 5.5, 5.0, 4.5, 4.0, 3.5, or 3.0. For example, the total content of low MW polyolefin in the asphalt composition may be from about 6 to about 9 wt. %, or from about 4 to about 10 wt. %, or from about 4.5 to about 9.5 wt. %, or from about 2 to about 12 wt. %, or even from about 5 to about 8.5 wt. %, based on the total weight of the asphalt composition.

In an exemplary embodiment, the asphalt compositions comprise low penetration grade asphalt(s) in addition to and/or comprising at least a part of the base asphalt. As used herein, the phrase “low penetration grade asphalt(s)” refers to asphalt(s) having a PEN of less than 10 tenths of a millimeter (dmm), such as less than 9, 8, 7, 6, 5, 4, 3, or 2 dmm, for example asphalts having a PEN of about 0. Low penetration grade asphalts are, for example, 0-pen asphalts. Penetration is measured at 25° C. according to ASTM D5. In an exemplary embodiment, the low penetration grade asphalt(s) is present in the asphalt composition in an amount of from about 0 to about 40% by weight based on the total weight of the asphalt composition. It is desired that the low penetration grade asphalt(s) is present in the asphalt composition in an amount, in wt. %, based on the total weight of the asphalt composition of at least about.5, 1, 1.5, 2, 2.5, 3, 3.5, 4, 4.5, or 5 and independently, of not more than about 35, 34, 33, 32, 31, 30, 29, or 28.5. For example, the total content of low penetration grade asphalt(s) in the asphalt composition may be from about 5 to about 35 wt. %, or from about 8 to about 12 wt. %, or from about 19 to about 35 wt. %, or even from about 5 to about 35 wt. %. It is to be appreciated that the weight range of the low penetration grade asphalt(s) will vary with different types or grades of the base asphalt used. The low penetration grade asphalt(s) add hardness to the base asphalt and include asphalts such as GILSONITE® (commercially available as indicated below), Trinidad Lake Asphalt, Sichuan Rock Asphalt (SC RA), Pitch, rock asphalt, and Solvent De-asphalted Asphalt (SDA), especially Propane De-asphalted Asphalt (PDA).

In an exemplary embodiment, the asphalt composition includes performance additives that are added to the asphalt composition in addition to the asphalt(s) and low MW polyolefin(s) and/or that are inherently present in, for example, modified asphalt(s) or the like used to form the asphalt composition. For example, performance additives include elastomer, plastomer, recycled plastic, recycled tire rubber, crumb rubber, ground tire rubber, oil, recycled oil, plasticizer, polyphosphoric acid (PPA), antioxidant, amine, polyamine, fire retardant, fungi (algae) resistance additive, and combinations thereof. Performance additives such as elastomers are well-known in the industry for use in asphalt roofing products to expand the temperature ranges at which such products can be used without serious defect or failure. The asphalt compositions may include one or more performance additives that are present in a total amount of less than or equal to about 20.0% by weight based on the total weight of the asphalt composition. For example, the asphalt composition may include an elastomer and/or other performance additive in a total amount of from about 0.1 to about 20.0% by weight based on the total weight of the asphalt composition. Non-limiting examples of elastomers include styrene/butadiene/styrene copolymer (SBS), linear low-density polyethylene (LLDPE), styrene/butadiene rubber (SBR), ethylene-glycidyl(meth)acrylate, (meth)acrylate terpolymers, and ethylene butyl acrylate (EBA).

In an exemplary embodiment, the filled asphalt material includes the asphalt composition in an amount of at least about 20% by weight such as from about 20% to about 40% by weight based on the total weight of the filled asphalt material. The filled asphalt composition further includes filler in an amount of from about 60% to about 80% by weight based on the total weight of the filled asphalt material. In an exemplary embodiment, the filler is a mineral filler. For example, suitable fillers include but are not limited to calcitic limestone filler, dolomitic limestone filler, fly ash, carbon black filler, stone dust, and combinations thereof. In an exemplary embodiment, the filler includes calcium carbonate and the calcium carbonate is present in the filler in an amount of less than about 91%, such as, less than about 90% by weight, based on the total weight of the filler. For example, in various embodiments the filler may include calcium carbonate in an amount of from 0 to about 90 weight percent, or from 0 to about 80 weight percent, or from 0 to about 50 weight percent, or from 0 to about 25 weight percent, all based on the total weight of the filler. In an exemplary embodiment, the filler may be free of calcium carbonate, such that the asphalt composition is free of calcium carbonate.

Typically, the filler has included calcium carbonate in an amount of at least about 91 weight percent, based on a total weight of the filler, where the higher concentration of calcium carbonate tends to increase the tear strength of the shingle. However, because the use of the low MW polyolefin produces increased tear strength with greater flexibility, and with greater adhesion to the substrate, a lower quality filler (i.e., a filler with lower quantities of calcium carbonate, such as less than 91%) can be used while still producing shingles with sufficient tear strength. The decreased quality of filler reduces the cost of production for the shingle.

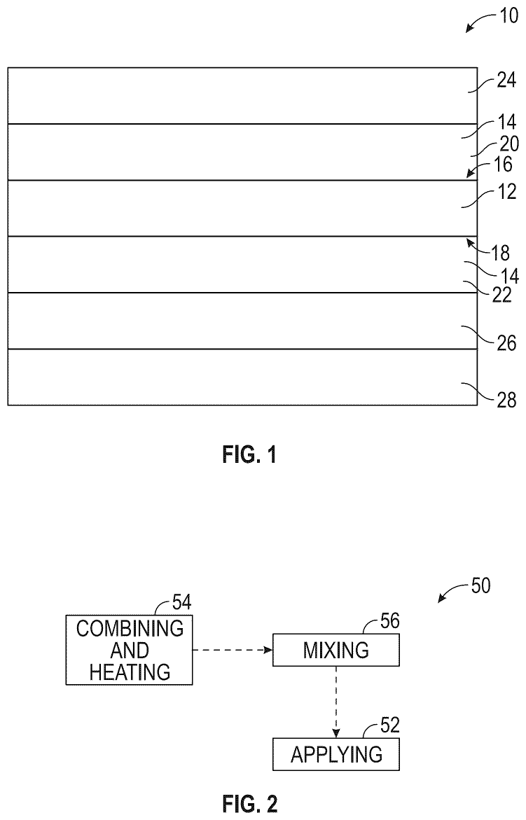

Referring to FIG. 1, a roofing shingle 10 in accordance with an exemplary embodiment is shown. In an exemplary embodiment, the roofing shingle 10 includes a substrate 12 and the filled asphalt material 14 is disposed on the substrate 12. For example, as illustrated, the substrate 12 has a first surface 16 and a second surface 18 that are disposed opposite of each other. The filled asphalt material 14 is disposed on the first and second surfaces 16 and 18 to form a first filled asphalt layer 20 and a second filled asphalt layer 22, respectively.

In an exemplary embodiment, the substrate 12 is selected from the group of fiberglass mat, polyester mat, fiberglass reinforced polyester mat, and combinations thereof. Due at least in part to the inclusion of low MW polyolefin in the filled asphalt material 14, the substrate 12 can be much lighter than current standard substrate weight and still comply with ASTM D3462 requirements. For example, the substrate 12 has a weight of less than or equal to about 88 grams per square meter (g/m²) based on the total surface area of the first surface 16. In an exemplary embodiment, the substrate 12 has a weight of from about 65 to about 90 g/m² based on the total surface area of the surface 16. In alternate embodiments, the substrate 12 has a weight of from about 65 to about 88 g/m², or from about 65 to about 85 g/m², or from about 65 to about 80 g/m². The low MW polyolefin added to the asphalt produces better adhesion of the asphalt composition to the substrate 12 with greater flexibility. Not to be bound by theory, but it thought that the improved adhesion and flexibility of the asphalt composition allows for the use of lighter weight substrates without compromising the tear strength or performance of the shingle.

In an exemplary embodiment, the roofing shingle 10 may include additional layers. For example, as illustrated, the roofing shingle 10 includes a granule layer 24 that is disposed on the first filled asphalt layer 20 on the side opposite the substrate 12. The granule layer 24 includes granule-sized aggregate such as crushed quarry rock or the like. “Aggregate” is a collective term for mineral materials, such as, for example, sand, gravel, or crushed stone. The aggregate may include natural aggregate, manufactured aggregate, or a combination thereof. Natural aggregate is typically extracted rock from an open excavation (e.g., a quarry) that is reduced to usable sizes by mechanical crushing. Manufactured aggregate is typically a byproduct of other manufacturing processes such as slag from metallurgical processing (e.g., steel, tin, and copper production). Manufactured aggregate also includes specialty materials that are produced to have a particular physical characteristic not found in natural rock, such as, for example, low density.

The roofing shingle 10 may further include a backing layer 26. As illustrated, the backing layer 26 is disposed on the second filled asphalt layer 22 on the side opposite the substrate. In an exemplary embodiment, the backing layer 26 includes a backing material selected from the group of backing sand, talc, slag, and combinations thereof.

Additionally, the roofing shingle 10 may include an adhesive 28. As illustrated, the adhesive 28 is an adhesive layer disposed on the backing layer 26 on the side opposite the second filled asphalt layer 22, however, various alternate embodiments of the adhesive 28 include the adhesive 28 as a continuous adhesive line, adhesive dots, or the like. In an exemplary embodiment, the adhesive 28 includes an adhesive selected from the group of laminate adhesive, shingle sealant, and combinations thereof. In an exemplary embodiment, the adhesive layer 28 may be disposed on top of/overlying the granule layer 24.

Although the roofing shingle 10 is illustrated as having a substrate 12, first and second asphalt layers 20 and 22, a granule layer 24, a backing layer 26, and adhesive 28, various alternate embodiments of the roofing shingle 10 includes the roofing shingle 10 including additional layers, substrates, and/or adhesives. For example, roofing shingle construction is well-known in the art and includes 3-tab roofing shingles, laminated shingles/architectural shingles, and the like.

Various performance characteristics of the roofing shingle 10 are of particular importance. In an exemplary embodiment, the roofing shingle 10 has a tear strength of from about 1700 g to about 4000 g as measured in accordance with ASTM D3462 along cross-machine direction. In an exemplary embodiment, the roofing shingle 10 has improved impact resistance over industry standard roofing shingles. In an exemplary embodiment, the total weight of the roofing shingle 10 is reduced by up to about 20% from industry standard roofing shingles. In an exemplary embodiment, the processing temperature of the roofing shingle 10 is reduced compared to industry standard roofing shingles.

Referring to FIG. 2, a method 50 for making a roofing shingle in accordance with an exemplary embodiment is provided. The method 50 includes applying (STEP 52) a filled asphalt material to a substrate. For example, the filled asphalt material may be applied to the substrate by coating the substrate with the filled asphalt material. The filled asphalt material includes an asphalt composition and a filler. The asphalt composition includes base asphalt and a low molecular weight (MW) polyolefin present in an amount of from about 0.5 to about 25.0% by weight based on the total weight of the asphalt composition.

In an exemplary embodiment, prior to applying the filled asphalt material, the method 50 includes combining and heating (STEP 54) the base asphalt and the low molecular weight polyolefin to make an asphalt composition. In an exemplary embodiment, the method 50 further includes mixing (STEP 56) the asphalt composition and the filler to make the filled asphalt material. In an exemplary embodiment, the roofing shingle is processed at a temperature of from about 350° F. to about 450° F.

The following examples are provided for illustration purposes only and are not meant to limit the various embodiments of the asphalt composition in any way.

### EXAMPLES

The following are examples of asphalt compositions including various base asphalts, low penetration grade asphalts, and/or low MW polyolefins. The base asphalt was heated to an elevated temperature of about 150 to about 220° C. to form a hot liquid asphalt, and the low penetration grade asphalt(s) and low MW polyolefin(s) were added to the hot liquid asphalt. The low penetration grade asphalt(s) and/or the low MW polyolefin(s) can be added to the hot liquid asphalt together, or one after the other, or pre-blended either by melt blend method or dry blend method. Then, the hot liquid asphalt/low penetration grade asphalt(s)/low MW polyolefin(s) mixture was blended for about 30 to about 240 minutes until a homogeneous blend is obtained.

Various properties of the asphalt compositions are presented and compared below. For example, properties relating to composition, softening point, penetration, and viscosity of the asphalt compositions are provided. The respective concentrations of the components in the asphalt compositions in the examples below are presented in weight percent (wt. %) based on the total weight of the respective asphalt composition, adding up to a total of 100 wt. % for each asphalt composition. As presented herein, softening point (SP) is measured in degree Celsius in accordance with the ASTM D36 method, penetration (PEN) is measured in deci-millimeters (dmm) at 25° C. in accordance with the ASTM D5 method, and viscosity is measured in centipoise (cPs) at 135° C. in accordance with the ASTM D4402 method. Asphalt compositions having a PEN of greater than or equal to 15 dmm and a SP of greater than or equal 88° C. and less than or equal to 113° C. for use in non-polymer modified shingles or less than or equal to 160° C. for use in polymer modified shingles are especially desirable.

ASTM D3462/D3462M lists physical property requirements on asphalt roofing shingles made with fiberglass mats. One such requirement is tear strength, which is measured in Newtons (N) or grams (g) at 23+/−2° C. in accordance with ASTM D1922 as modified in ASTM D228/D228M. Tear strength can be measured either along shingle production machine direction (MD) or cross-machine direction (CMD). ASTM D3462/D3462M requires asphalt roofing shingles to have a minimum cross-machine direction (CMD) tear strength of 16.7 N or 1700 g. It is accepted by the roofing industry that higher tear strength will result in better shingle performance on a roof. Roofing shingle tensile strength is measured in lbf/in at 23+/−2° C. in accordance with ASTM D412, and it is also accepted by the roofing industry that higher tensile strength will result in better shingle performance on a roof. According to ASTM D3462, filler loading is the mass percentage of the mineral filler passing a No. 70 (212 um) sieve of the total mass of asphalt and mineral filler passing a No. 70 (212 um) sieve. In general, filler is much less expensive than asphalt, and higher filler loading, for example, helps to reduce asphalt roofing shingle cost.

Roofing shingle processing temperature refers to the temperature at which the filled asphalt material coats the fiberglass mat at a roofing shingle plant. Due to the high viscosity of the filled asphalt material made with blown coating, roofing shingle plants generally use an elevated temperature, such as 450-500° F., as their processing temperature to produce asphalt roofing shingles. It is beneficial for asphalt roofing shingle processing temperature to be reduced. A reduced roofing shingle processing temperature will help to reduce both energy cost and environmental emissions at roofing shingle plants.

### Example 1: Effect of Low MW Polyolefins and GILSONITE® on Various Asphalt Composition Characteristics

Samples in Table 1 range in concentration of PG 64-22 asphalt, GILSONITE®, HONEYWELL TITAN® 8903, and HONEYWELL TITAN® 8822. PG 64-22 is a base asphalt that is optimally utilized in a climate where the pavement temperature ranges anywhere between 64° C. and −22° C. PG 64-22 has a SP of about 48° C. and a PEN of about 71 to about 75 dmm. GILSONITE® is the registered trademark for a form of natural uintaite or uintahite found only in Utah and resembles shiny black obsidian. GILSONITE® is a low penetration grade asphalt, and the sample used in the following examples having a SP of about 212° C. and a PEN of zero. GILSONITE® is commercially available, for example, from American Gilsonite Company, located in Bonanza, Utah, U.S.A. HONEYWELL TITAN® 8903 is a low MW polyolefin. More specifically, HONEYWELL TITAN® 8903 is a functionalized high-density polyethylene that is an oxidized high-density polyethylene. HONEYWELL TITAN® 8822 is a low MW polyolefin. More specifically, HONEYWELL TITAN® 8822 is a functionalized polypropylene that is a maleic anhydride-grafted polypropylene.

TABLE 1

| | | | | | Tot. Low | | | |
|---|---|---|---|---|---|---|---|---|
| | | | | | MW | | | |
| Sample | PG 64-22 | Gilsonite ® | 8903 | 8822 | Polyolefin | Visc. | PEN | SP |
| Control 1 | 100 | — | — | — | — | 430 | 74 | 47.6 |
| Control 2 | — | 100 | — | — | — | — | 0 | 212 |
| 1 | 80 | 20 | — | — | — | 2563 | 13 | 69.2 |
| 2 | 83 | 17 | — | — | — | 1890 | 15 | 66.6 |
| 3 | 78 | 15 | 7 | — | 7 | 2350 | 9 | 102.0 |
| 4 | 76 | 15 | 7 | 2 | 9 | 2950 | 11 | 112.7 |
| 5 | 76 | 15 | 9 | — | 9 | 2750 | 12 | 104.1 |
| 6 | 76 | 15 | — | 9 | 9 | 9025 | 12 | 94.8 |
| 7 | 78 | 15 | 5 | 2 | 7 | 2830 | 12 | 108.2 |
| 8 | 76 | 15 | 8 | 1 | 9 | 2750 | 12 | 108.0 |
| 9 | 78 | 15 | — | 7 | 7 | 4850 | 13 | 91.0 |
| 10 | 78 | 15 | 6 | 1 | 7 | 2380 | 13 | 100.1 |
| 11 | 85 | 15 | — | — | — | 1638 | 16 | 61.3 |
| 12 | 80 | 15 | 5 | — | 5 | 2010 | 16 | 80.2 |
| 13 | 80 | 15 | — | 5 | 5 | 3610 | 16 | 71.8 |
| 14 | 85 | 12 | 3 | — | 3 | 1225 | 17 | 66.5 |
| 15 | 83 | 12 | — | 5 | 5 | 2680 | 18 | 71.5 |
| 16 | 83 | 12 | 5 | — | 5 | 1550 | 19 | 78.3 |
| 17 | 85 | 10 | 3 | 2 | 5 | 1675 | 16 | 74.1 |
| 18 | 83 | 10 | — | 7 | 7 | 7850 | 18 | 83.1 |
| 19 | 83 | 8 | 9 | — | 9 | 3750 | 9 | 103.0 |
| 20 | 83 | 8 | 5.4 | 3.6 | 9 | 6162 | 11 | 111.4 |
| 21 | 83 | 8 | — | 9 | 9 | 6780 | 15 | 84.9 |
| 22 | 85 | 8 | — | 7 | 7 | 8480 | 16 | 82.2 |
| 23 | 81 | 12 | 7 | — | 7 | 1710 | 15 | 96.0 |
| 24 | 81 | 12 | 5 | 2 | 7 | 2040 | 15 | 89.4 |
| 25 | 82 | 12 | 6 | — | 6 | 1650 | 16 | 89.9 |
| 26 | 81 | 12 | 6 | 1 | 7 | 1823 | 16 | 96.0 |
| 27 | 81 | 10 | — | 9 | 9 | 10880 | 15 | 102.4 |
| 28 | 83 | 10 | 5 | 2 | 7 | 2050 | 16 | 111.6 |
| 29 | 83 | 10 | 6 | 1 | 7 | 1860 | 16 | 96.8 |
| 30 | 81 | 10 | 8 | 1 | 9 | 2150 | 16 | 106.0 |
| 31 | 81 | 10 | 9 | — | 9 | 1580 | 17 | 105.1 |
| 32 | 81 | 10 | 7 | 2 | 9 | 2390 | 17 | 101.8 |
| 33 | 83 | 10 | 7 | — | 7 | 1630 | 18 | 96.5 |
| 34 | 85 | 8 | 4 | 3 | 7 | 1900 | 15 | 113.3 |
| 35 | 85 | 8 | 7 | — | 7 | 1600 | 16 | 96.5 |

The data presented in Table 1 provides a comparison between the properties of asphalt compositions that have varied compositions. Notably, samples 1-22 do not meet the standards for especially desirable asphalt compositions as defined herein as having a PEN of at least 15 dmm and an SP of at least 88° C., and samples 23-35 do meet these standards. Comparing samples 1-22 to samples 23-35, it is shown that asphalt compositions comprising GILSONITE® in an amount of from about 8 to about 12 wt. % and low MW polyolefin(s) in an amount of from about 6 to about 9 wt. % based on the total weight of the asphalt composition are especially desirable. Additionally, it may be desirable that the base asphalt is present in an amount of from about 81.0 to about 85.0 wt. %. Optimal compositions might change due to the variability in base asphalt and in uintaite or uintahite used in asphalt composition.

### Example 2: Effect of Low MW Polyolefins and PDA on Various Composition Characteristics

Samples in Table 2 range in concentration of PG 64-22, PDA, HONEYWELLL TITAN® 8903, HONEYWELL TITAN® 8822, HONEYWELL TITAN® 8587, HONEYWELL TITAN® 8760, and HONEYWELL TITAN® 8636. General properties of PG 64-22, HONEYWELL TITAN® 8903, and HONEYWELL TITAN® 8822 are discussed above. PDA is a low penetration grade asphalt having a SP of about 79° C. and a PEN of about 0 dmm. HONEYWELL TITAN® 8587 is a low MW polyolefin. More specifically, HONEYWELL TITAN® 8587 is a functionalized high-density polyethylene that is an oxidized polyethylene. HONEYWELL TITAN® 8760 is a low MW polyolefin. More specifically, HONEYWELL TITAN® 8760 is a functionalized polyethylene that is an oxidized polyethylene. HONEYWELL TITAN® 8636 is a low MW polyolefin. More specifically, HONEYWELL TITAN® 8636 is a functionalized polyethylene that is an oxidized polyethylene.

TABLE 2

| | PG | | | | | | | Tot. | | | |
|---|---|---|---|---|---|---|---|---|---|---|---|
| | 64- | | | | | | | Low | | | |
| Sample | 22 | PDA | 8903 | 8822 | 8587 | 8760 | 8636 | MW | Visc. | PEN | SP |
| Control 1 | — | 100 | — | — | — | — | — | — | 3742 | 0 | 78.9 |
| Control 2 | 100 | — | — | — | — | — | — | — | 401 | 71 | 47.5 |
| 1 | 50 | 50 | — | — | — | — | — | — | — | 11 | 65.7 |
| 2 | 48.5 | 48.5 | 3 | — | — | — | — | 3 | 1229 | 8 | 69.6 |
| 3 | 48.5 | 48.5 | — | 3 | — | — | — | 3 | 2414 | 9 | 70.2 |
| 4 | 48.5 | 48.5 | 1.8 | 1.2 | — | — | — | 3 | 1919 | 8 | 70.2 |
| 5 | 60 | 40 | — | — | — | — | — | — | 2750 | 18 | 61.4 |
| 6 | 70 | 30 | — | — | — | — | — | — | 693 | 26 | 56.6 |
| 7 | 67.9 | 29.1 | 3 | — | — | — | — | 3 | 791 | 18 | 68.4 |
| 8 | 67.9 | 29.1 | — | 3 | — | — | — | 3 | 1759 | 20 | 73.6 |
| 9 | 67.9 | 29.1 | 1.8 | 1.2 | — | — | — | 3 | 1173 | 20 | 65.2 |
| 10 | 67.2 | 28.8 | — | 4 | — | — | — | 4 | 2053 | 18 | 75.6 |
| 11 | 66.9 | 28.7 | — | 4.5 | — | — | — | 4.5 | 2093 | 17 | 76.7 |
| 12 | 66.5 | 28.5 | 5 | — | — | — | — | 5 | 924 | 15 | 77 |
| 13 | 66.5 | 28.5 | 3 | 2 | — | — | — | 5 | 1611 | 16 | 81.2 |
| 14 | 80 | 20 | — | — | — | — | — | — | 1225 | 35 | 54.5 |
| 15 | 72.5 | 19 | — | 8.5 | — | — | — | 8.5 | 2680 | 20 | 68 |
| 16 | 90 | 10 | — | — | — | — | — | — | — | 51 | 50.7 |
| 17 | 66.5 | 28.5 | — | 5 | — | — | — | 5 | 2284 | 15 | >100 |
| 18 | 66.5 | 28.5 | — | 1.65 | 3.35 | — | — | 5 | 1500 | 16 | 107.7 |
| 19 | 66.5 | 28.5 | — | 1 | 4 | — | — | 5 | 1050 | 21 | 97.3 |
| 20 | 65.8 | 28.2 | — | 2 | 4 | — | — | 6 | 1693 | 17 | 99.6 |
| 21 | 65.8 | 28.2 | — | 2 | — | 4 | — | 6 | 1780 | 17 | 107 |
| 22 | 65.8 | 28.2 | 4 | 2 | — | — | — | 6 | 1750 | 19 | 101.5 |
| 23 | 65.8 | 28.2 | — | 2 | — | — | 4 | 6 | 1253 | 28 | 115.4 |
| 24 | 72.5 | 19 | 8.5 | — | — | — | — | 8.5 | — | 18 | 94.1 |
| 25 | 72.5 | 19.0 | 5.7 | 2.8 | — | — | — | 8.5 | — | 21 | 114 |

The data presented in Table 2 provides a comparison between the properties of asphalt compositions that have varied compositions. Notably, samples 1-16 do not meet the standards for especially desirable asphalt compositions as defined herein as having a PEN of at least 15 dmm and an SP of at least 88° C., and samples 17-25 do meet these standards. Comparing samples 1-16 to samples 17-25, it is shown that asphalt compositions comprising PDA in an amount of from about 19 to about 28.5 wt. % and low MW polyolefin(s) in an amount of from about 5 to about 8.5 wt. % based on the total weight of the asphalt composition are especially desirable. Additionally, it may be desirable that the base asphalt is present in an amount of from about 65.8 to about 72.5 wt. %. Optimal compositions might change due to the variability in base asphalt and in PDA used in asphalt composition.

### Example 3: Effect of HONEYWELL TITAN® 8903 and Low Penetration Grade Asphalts on Various Asphalt Composition Characteristics

Samples in Table 3 range in concentration of SK-70 base asphalt, GILSONITE®, Trinidad Lake Asphalt (TLA), SC RA, Pitch, and HONEYWELL TITAN® 8903. General properties of GILSONITE® are discussed above. SK-70 is a base asphalt that has a SP of about 48° C. and a PEN of about 60 to about 80 dmm. TLA, SC RA, and Pitch are all low penetration grade asphalts having a PEN of about, or nearly 0. HONEYWELL TITAN® 8903 is a low MW polyolefin. More specifically, HONEYWELL TITAN® 8903 is a functionalized polyethylene that is an oxidized high-density polyethylene.

TABLE 3

| Sample | Control | 1A | 1B | 2A | 2B | 3A | 3B | 4A | 4B | 4C |
|---|---|---|---|---|---|---|---|---|---|---|
| SK-70 | 100 | 90 | 85 | 75 | 70 | 90 | 85 | 90 | 85 | 80 |
| Gilsonite | — | 10 | 10 | — | — | — | — | — | — | — |
| TLA | — | — | — | 25 | 25 | — | — | — | — | — |
| SC RA | — | — | — | — | — | 10 | 10 | — | — | — |
| Pitch | — | — | — | — | — | — | — | 10 | 10 | 15 |
| 8903 | — | — | 5 | — | 5 | — | 5 | — | 5 | 5 |
| Tot. Low | — | — | 5 | — | 5 | — | 5 | — | 5 | 5 |
| MW | | | | | | | | | | |
| Polyolefin | | | | | | | | | | |
| Visc. | 418 | 1035 | 1280 | 680 | 906 | 1265 | 1710 | 672 | 817 | 895 |
| PEN | 73 | 27.6 | 19.8 | 35.2 | 25.1 | 29.6 | 19.6 | 35.3 | 26.2 | 23.5 |
| SP | 46 | 66.1 | 88.2 | 55.1 | 110 | 60.7 | 91.5 | 55.2 | 78.6 | 89.2 |

The data presented in Table 3 provides a comparison between the properties of asphalt compositions that have varied compositions. Notably, samples 1A and 1B include GILSONITE® as the low penetration grade asphalt, samples 2A and 2B include TLA as the low penetration grade asphalt, samples 3A and 3B include SC RA as the low penetration grade asphalt, and samples 4A, 4B, and 4C include Pitch as the low penetration grade asphalt. Samples 1A, 2A, 3A, 4A, and 4B do not meet the standards for especially desirable asphalt compositions as defined herein as having a PEN of at least 15 dmm and an SP of at least 88° C., and samples 1B, 2B, 3B, and 4C do meet these standards. Comparing sample 1A to 1B, it is shown that asphalt compositions comprising GILSONITE® in an amount of about 10 wt. % and low MW polyolefin(s) in an amount of about 5 wt. % based on the total weight of the asphalt composition are especially desirable. Comparing sample 2A to 2B, it is shown that asphalt compositions comprising TLA in an amount of about 25 wt. % and low MW polyolefin(s) in an amount of about 5 wt. % based on the total weight of the asphalt composition are especially desirable. Comparing sample 3A to 3B, it is shown that asphalt compositions comprising SC RA in an amount of about 10 wt. % and low MW polyolefin(s) in an amount of about 5 wt. % based on the total weight of the asphalt composition are especially desirable. Comparing sample 4A, 4B, and 4C, it is shown that asphalt compositions comprising Pitch in an amount of about 15 wt. % and low MW polyolefin(s) in an amount of about 5 wt. % based on the total weight of the asphalt composition are especially desirable.

### Example 4: Comparison of Performance Characteristics of Oxidized Asphalts and Exemplary Asphalt Compositions Contemplated Herein Utilized in Roofing Shingles

Samples in Table 4 compare control samples of roofing shingles including a blown oxidized asphalt coating as the asphalt composition with roofing shingles including an asphalt composition comprising PG 64-22, PDA, GILSONITE®, and low MW polyolefin(s) including HONEYWELL TITAN® 8822, HONEYWELL TITAN® 8903, and/or HONEYWELL TITAN® 8587. General properties of PG 64-22, PDA, GILSONITE®, HONEYWELL TITAN® 8822, HONEYWELL TITAN® 8903, and HONEYWELL TITAN® 8587 are discussed above.

TABLE 4

| Sample | Control 1 | Control 2 | 1 | 2 | 3 | 4 | 5 |
|---|---|---|---|---|---|---|---|
| Oxidized Asphalt | 100 | 100 | — | — | — | — | — |
| (Blown Coating) | | | | | | | |
| PG6 4-22 | — | — | 66.5 | 66.5 | 66.5 | 81.0 | 81.0 |
| PDA | — | — | 28.5 | 28.5 | 28.5 | — | — |
| GILSONITE ® | — | — | — | — | — | 12.0 | 12.0 |
| 8822 | — | — | 1.0 | 1.0 | 1.0 | 1.0 | 1.0 |
| 8903 | — | — | — | — | — | 6.0 | 6.0 |
| 8587 | — | — | 4.0 | 4.0 | 4.0 | — | — |
| Standard Fiberglass | X | — | X | X | — | X | — |
| Mat (85 g/m²) | | | | | | | |
| Light-weight | — | X | — | — | X | — | X |
| Fiberglass Mat (75 | | | | | | | |
| g/m²) | | | | | | | |
| Standard Filler | X | X | X | — | X | — | — |
| Loading (65%) | | | | | | | |
| High Filler Loading | — | — | — | X | — | X | X |
| (70%) | | | | | | | |
| Standard Processing | X | X | — | X | — | X | X |
| Temperature (475° F.) | | | | | | | |
| Low Processing | — | — | X | — | X | — | — |
| Temperature (400° F.) | | | | | | | |
| Tear Strength MD (g) | 1296 | 614.4 | 1644.8 | 1299.2 | 1625.6 | 2099.2 | 1859.2 |
| Tear Strength CMD | 931.2 | 560 | 1286.4 | 1244.8 | 1292.8 | 1564.8 | 1561.6 |
| (g) | | | | | | | |
| Tensile Strength MD | 94.7 | 54.8 | 133.4 | 128.3 | 88.2 | 135.6 | 103.4 |
| (lbf/in) | | | | | | | |
| Tensile Strength | 40.3 | 31.4 | 66.4 | 73 | 73.2 | 70.1 | 82.2 |
| CMD (lbf/in) | | | | | | | |

The data presented in Table 4 provides a comparison between the properties of roofing shingles that have varied substrates and/or asphalt compositions. Notably, control 1 and control 2 include 100 wt. % blown oxidized asphalt as the asphalt composition. Control 1 utilizes a standard fiberglass mat with standard filler loading and standard processing temperature. Control 2 utilizes a light-weight glass mat with standard filler loading and standard processing temperature. Samples 1-5 vary in asphalt composition and substrate, but all of samples 1-5 include a low MW polyolefin. Comparing the controls with the samples 1-5, it is shown that samples 1-5 have superior tear strength in all cases, regardless of substrate, filler loading, and processing temperature. Additionally, it is shown that samples 1-5 have superior tensile strength in all cases, regardless of substrate, filler loading, and processing temperature. Accordingly, the asphalt compositions of samples 1-5 outperform the asphalt compositions of controls 1 and 2 when utilized in forming roofing shingles. This allows for the use of lighter-weight mats, higher filler loading, and lower processing temperature without compromising tear strength and tensile strength. Tear strength and tensile strength are indicative of roofing shingle longevity and durability, and therefore the asphalt compositions of samples 1-5 allow for roofing shingles that have lightweight mats with higher filler loading and lower processing temperature without compromising durability and longevity of the roofing shingles. Additionally, this allows for roofing shingle manufacturers to produce such shingles with an overall lighter weight.

### Example 5: Aging Effects for Asphalt Shingles

Examples in Tables 5-10 show the aging effects for various asphalt compositions that may be used for shingles. The base asphalt used was PG 64-22, SBS stands for styrene/butadiene/styrene block copolymer, 7686 stands for Honeywell® TITAN® 7686, which is a type of low molecular weight polyolefin, 8995 stands for Honeywell® TITAN® 8995, which is a low molecular weight polyolefin blend, roofing blown coating is oxidized asphalt, and aged roofing blown coating is the asphalt recovered from roofing shingles that had aged in use, CM G* is the complex modulus, which is measured in Pascals (Pa) at 20° C. in accordance with the ASTM D7175 method, phase angle is measured in degrees at 20° C. in accordance with the ASTM D7175 method, and PAV stands for pressurized aging vessel, which is operated at 100° C. in accordance with the ASTM D6521 method. Poor aging quality is indicated by a larger increase in the complex modulus G* over the aging time, as well as a larger drop in the phase angle over the aging time. According to multiple recent research projects, after aging, a phase angle of 27 degrees or higher is desirable for better roofing shingle longevity, where the performance of asphalt compositions with phase angles below 27 degrees are questionable.

TABLE 5

| | Aging Condition | | | | |
|---|---|---|---|---|---|
| Composition | (PAV hours) | Unaged | 20 | 40 | 60 |
| PG 64-22 | CM G* (Pa) | 5.65E+06 | 1.39E+07 | 2.17E+07 | 2.91E+07 |
| | Phase Angle (°) | 58.8 | 43.8 | 37.9 | 34.7 |
| PG 64-22 + | CM G* (Pa) | 7.07E+06 | 1.91E+07 | 2.85E+07 | 3.52E+07 |
| 3.5% SBS | Phase Angle (°) | 53.07 | 39.65 | 34.8 | 31.17 |
| PG 64-22 + | CM G* (Pa) | 1.35E+07 | 2.05E+07 | 2.84E+07 | 3.30E+07 |
| 3.5% 7686 | Phase Angle (°) | 48.34 | 42.41 | 37.28 | 34.17 |
| PG 64-22 + | CM G* (Pa) | 9.87E+06 | 1.75E+07 | 2.80E+07 | 3.38E+07 |
| 1.75% SBS + | Phase Angle (°) | 51.7 | 41.03 | 34.83 | 33.32 |
| 1.75% 7686 | | | | | |

TABLE 6

| | Aging Condition | | | |
|---|---|---|---|---|
| Composition | (PAV hrs) | 20 | 40 | 60 |
| PG 64-22 | Aging Index | 2.46 | 3.84 | 5.15 |
| | (vs. unaged) | | | |
| PG 64-22 + | Aging Index | 2.70 | 4.03 | 4.98 |
| 3.5% SBS | (vs. unaged) | | | |
| PG 64-22 + | Aging Index | 1.52 | 2.10 | 2.44 |
| 3.5% 7686 | (vs. unaged) | | | |
| PG 64-22 + | Aging Index | 1.77 | 2.84 | 3.42 |
| 1.75% SBS + | (vs. unaged) | | | |
| 1.75% 7686 | | | | |

TABLE 7

| | Aging Condition | | | |
|---|---|---|---|---|
| Composition | (PAV hrs) | 20 | 40 | 60 |
| PG 64-22 | phase angle drop | 15.00 | 20.90 | 24.10 |
| | (vs. unaged) | | | |
| PG 64-22 + | phase angle drop | 13.42 | 18.27 | 21.90 |
| 3.5% SBS | (vs. unaged) | | | |
| PG 64-22 + | phase angle drop | 5.93 | 11.06 | 14.17 |
| 3.5% 7686 | (vs. unaged) | | | |
| PG 64-22 + | phase angle drop | 10.67 | 16.87 | 18.38 |
| 1.75% SBS + | (vs. unaged) | | | |
| 1.75% 7686 | | | | |

TABLE 8
for roofing shingle blown coating (oxidized asphalt)

| aging condition | Phase angle |
|---|---|
| (PAV hrs) | (degrees) |
| 0 | 30.1 |
| 20 | 24.9 |
| 40 | 21.9 |

TABLE 9
for aged roofing shingle blown coating
from recycled asphalt shingles (RAS)

| aging condition | phase angle (degrees) |
|---|---|
| from a roof | 23.2 |

TABLE 10
for PG 64-22 + 12% 8995

| aging condition | Phase angle |
|---|---|
| (PAV hrs) | (degrees) |
| 0 | 44.4 |
| 20 | 36.3 |
| 40 | 31.9 |

Tables 5-10 illustrate that improved aging with unoxidized asphalt and a low molecular weight polyolefin are possible, especially when compared to one or more of (i) oxidized asphalt, (ii) the PAV-aged roofing shingle blown coating (Table 8) and (iii) real-climate aged roofing shingle blown coating (Table 10). Table 5 shows the complex modulus G* and phase angle of 4 asphalt compositions before and after PAV-aging for 20, 40, and 60 hrs, respectively.

Table 6 shows the increase of the complex modulus G* of these 4 asphalt compositions upon PAV-aging, indicated by a parameter called “aging index”, which is the ratio of complex modulus G* of PAV-aged asphalt compositions over complex modulus G* of unaged asphalt compositions. Poor roofing shingle aging resistance or poor service longevity will be indicated by a higher aging index, which will also result in a poor recyclability of used roofing shingle for paving applications due to the higher brittleness of aged-asphalt in used roofing shingle. Table 6 shows the asphalt composition with 3.5% 7686 has the lowest aging index at all three PAV-aging times, followed by the asphalt composition with 1.75% SBS+1.75% 7686. The asphalt composition with 3.5% SBS shows an aging index similar to the unmodified PG 64-22 asphalt. In other words, low molecular weight polyolefin polymers like Honeywell Titan® 7686 can slow down the aging of asphalt up to about 50%. There will be at least two benefits from this: 1) the roofing shingle longevity will be significantly increased; 2) the roofing shingle's recyclability after use will be significantly increased due to reduced aging (lower brittleness of aged-asphalt in used roofing shingle), such that the paving industry can incorporate more used roofing shingles into paving applications.

Table 7 shows the decrease of phase angle for the same set of 4 asphalt compositions upon PAV-aging, indicated by a parameter called “phase angle drop”, which is the difference between the phase angle of PAV-aged asphalt compositions and the phase angle of unaged asphalt compositions. Poor roofing shingle aging resistance or poor service longevity will be indicated by a higher phase angle drop, which will also result in a poor recyclability of used roofing shingle for paving applications due to the higher brittleness of aged-asphalt in used roofing shingle. Table 7 shows the asphalt composition with 3.5% 7686 has the lowest phase angle drop at all three PAV-aging times, followed by the asphalt composition with 1.75% SBS+1.75% 7686. Asphalt composition with 3.5% SBS shows a phase angle drop similar to the unmodified PG 64-22 asphalt. In other words, low molecular weight polyolefin polymers like Honeywell Titan® 7686 can slow down the aging of asphalt in roofing shingle, indicated by a reduced phase angle drop upon aging. There will be at least two benefits from this: 1) the roofing shingle longevity will be significantly increased; 2) the roofing shingle's recyclability after use will be significantly increased due to reduced aging (lower brittleness of aged-asphalt in used roofing shingle), such that the paving industry can incorporate more used roofing shingles into paving applications.

Table 8 shows the phase angle drop of a roofing shingle asphalt (also called “blown coating”) upon PAV aging. Since the roofing shingle asphalt needs to go through an oxidation process to meet physical property requirements (such as penetration and softening point, etc.) in accordance with the ASTM D3462/D3462M, even before any PAV aging, it already has a fairly low phase angle of 30.1 degrees, which is very close to the “>=27 degrees” phase angle limit from recent studies. After 20-hr PAV aging, the roofing shingle asphalt phase angle dropped to 24.9 degrees, which is below the 27 degrees limit. This indicates the roofing shingle will have limited longevity and poor recyclability after use.

Table 9 shows the phase angle value of a roofing shingle asphalt recovered from a used shingle from a house roof. The recovered roofing shingle asphalt has a phase angle of 23.2 degrees, which confirms recent studies' proposed roofing shingle asphalt phase angle limit of “>=27 degrees”.

Table 10 shows the aging behavior of another roofing shingle asphalt which is made with 12% Honeywell Titan® 8995, a low molecular weight polyolefin blend. The roofing shingle asphalt in Table 10 also meets all physical property requirements in accordance with the ASTM D3462/D3462M. Compared with the roofing shingle asphalt in Table 8, this roofing shingle asphalt containing 8995 has a much higher phase angle. Even after 40-hr PAV aging, its phase angle is 31.9 degrees, which is still above the 27 degrees limit. The higher phase angle of this roofing shingle asphalt containing 8995 indicates a much better roofing shingle longevity and a much better roofing shingle recyclability after use.

While at least one exemplary embodiment has been presented in the foregoing detailed description of the disclosure, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing an exemplary embodiment of the disclosure. It being understood that various changes may be made in the function and arrangement of elements described in an exemplary embodiment without departing from the scope of the disclosure as set forth in the appended claims.

What is claimed is:

1. A roofing shingle comprising:
a substrate having a substrate weight of from about 65 to about 90 grams per square meter (g/m²), based on a total surface area of the substrate; and
a filled asphalt material that is disposed on the substrate, the filled asphalt material comprising:
an asphalt composition comprising:
base asphalt that is unoxidized, and
a low molecular weight (MW) polyolefin present in an amount of from about 0.5 to about 25.0% by weight based on a total weight of the asphalt composition; and
wherein the asphalt composition comprises a filler, wherein the filler comprises calcium carbonate in an amount of from 0 to about 90 weight percent, based on a total weight of the filler.

2. The roofing shingle of claim 1, wherein the low MW polyolefin is selected from the group of a functionalized polyolefin, a non-functionalized polyolefin, and combinations thereof.

3. The roofing shingle of claim 2, wherein the low MW polyolefin comprises the functionalized polyolefin, and wherein the functionalized polyolefin is selected from the group of oxidized high-density polyethylene, maleic anhydride-grafted polypropylene, maleic anhydride-grafted polyethylene, maleic anhydride-grafted poly(ethylene-co-propylene), polyethylene-vinyl acetate, ethylene-acrylic acid copolymer, oxidized medium-density polyethylene, oxidized low-density polyethylene, oxidized polyethylene-vinyl acetate, epoxy-functionalized polyolefin, Fischer-tropsch waxes, thermally degraded waxes, and combinations thereof.

4. The roofing shingle of claim 2, wherein the low MW polyolefin comprises the non-functionalized polyolefin, and wherein the non-functionalized polyolefin is selected from the group of polyethylene, polypropylene, ethylene-propylene copolymer, Fischer-tropsch waxes, thermally degraded waxes, and combinations thereof.

5. The roofing shingle of claim 1, wherein the base asphalt is present in an amount of from about 55 to about 99.5% by weight, based on the total weight of the asphalt composition.

6. The roofing shingle of claim 1, wherein the asphalt composition further comprises a performance additive selected from the group of elastomer, plastomer, recycled plastic, recycled tire rubber, crumb rubber, ground tire rubber, oil, recycled oil, plasticizer, polyphosphoric acid (PPA), antioxidant, amine, polyamine, fire retardant, fungi resistance additive, and combinations thereof.

7. The roofing shingle of claim 1, wherein the asphalt composition further comprises a low penetration grade asphalt having a penetration grade (PEN) of less than 10 tenths of a millimeter (dmm).

8. The roofing shingle of claim 7, wherein the base asphalt comprises the low penetration grade asphalt in an amount of from about 5 to about 35 weight percent, based on a total weight of the base asphalt.

9. The roofing shingle of claim 1, wherein the substrate has a first surface and a second surface that is disposed opposite the first surface, and wherein the filled asphalt material is disposed on the first surface and the second surface to form a first filled asphalt layer and a second filled asphalt layer, respectively.

10. The roofing shingle of claim 9 further comprising a backing layer disposed on the second filled asphalt layer on a side opposite the substrate, and wherein the backing layer comprises a backing material selected from the group of backing sand, talc, slag, and combinations thereof.

11. The roofing shingle of claim 10, wherein the roofing shingle has a tear strength of from about 1700 g to about 4000 g as measured in accordance with ASTM D3462 along cross-machine direction.

12. The roofing shingle of claim 9, wherein the substrate has a weight of from about 65 g/m² to about 80 g/m² based on the total surface area of the first surface.

13. The roofing shingle of claim 1, wherein the filler is selected from the group of calcitic limestone filler, dolomitic limestone filler, fly ash, carbon black filler, stone dust, and combinations thereof.

14. The roofing shingle of claim 13, wherein the filler comprises calcium carbonate in an amount of from 0% to about 50% by weight, based on the total weight of the filler.

15. The roofing shingle of claim 1, wherein the filler is present in the filled asphalt material in an amount of from about 60 to about 80% by weight based on the total weight of the filled asphalt material.

16. The roofing shingle of claim 15, wherein the asphalt composition is present in the filled asphalt material in an amount of at least about 20% by weight based on the total weight of the filled asphalt material.

17. The roofing shingle of claim 1, wherein the substrate is selected from the group of fiberglass mat, polyester mat, fiberglass reinforced polyester mat, and combinations thereof.

18. The roofing shingle of claim 1, wherein the substrate has a weight of from about 65 to about 80 g/m², and the filler comprises calcium carbonate in an amount of from 0 to about 25 weight percent.

19. A method for making a roofing shingle, the method comprising the steps of:
applying a filled asphalt material to a substrate, wherein the substrate has a substrate weight of from about 65 to about 90 grams per square meter (g/m²), based on a surface area of a first surface of the substrate, wherein the filled asphalt material comprises:
an asphalt composition comprising:
base asphalt that is unoxidized;
a low molecular weight (MW) polyolefin present in an amount of from about 0.5 to about 25.0% by weight based on a total weight of the asphalt composition; and
a filler, wherein the filler comprises calcium carbonate in an amount of from 0 to about 80 weight percent, based on a total weight of the filler.

20. The method of claim 19 further comprising the step of processing the roofing shingle at a temperature of from about 350° F. to about 450° F.
